(19) United States
(12) Patent Application Publication
(10) Pub. No.: US 2021/0188136 A1
(43) Pub. Date: Jun. 24, 2021

(54) ADJUSTABLE CHILD SEAT

(71) Applicant: Ellen Goldman, Lumberton, MS (US)

(72) Inventor: Ellen Goldman, Lumberton, MS (US)

(21) Appl. No.: 16/720,606

(22) Filed: Dec. 19, 2019

(51) Int. Cl. B60N 2/28; B60N 2/90

(52) U.S. Cl. CPC B60N 2/2869; B60N 2002/981; B60N 2/90; B60N 2/2821

(57) ABSTRACT

An adjustable child seat, including a main seat body to receive a user thereupon, a pivoting dome disposed on at least a portion of a bottom surface of the main seat body, a seat base to removably connect to the pivoting dome, such that the main seat body pivots with respect to the seat base via the pivoting dome, and rotates in response to a rotation of the seat base, and an alarm unit disposed on at least a portion of the seat base, the alarm unit including a tether disposed on at least a portion of the alarm unit to connect to a parent, such that the alarm unit generates an alert in response to the parent exceeding a range of the tether.

### BACKGROUND

### 1. Field

The present general inventive concept relates generally to a seat, and particularly, to an adjustable child seat.

### 2. Description of the Related Art

A child seat is a necessary addition in a vehicle when a parent or guardian brings a young child in the vehicle during travel. A standard vehicle seat is usually too large for the young child to sit in, safely. In particular, a seatbelt could cause significant injury to the young child in the event of an accident, or the seatbelt may not even reach the young child at all.

As such, vehicle seats are a pertinent part of child safety in motor vehicles and are commonly used by the parent or guardian to ensure the security of their children. However, the child seat is not adjustable, and the parent or guardian often has difficulty securing their children and positioning the child seat correctly in the vehicle. Also, the child seats have no installed alarms, resulting in children who may be left in unattended vehicles.

Therefore, there is a need for an adjustable child seat that alerts the parent or guardian leaving the vehicle that their child is still in the vehicle.

### SUMMARY

The present general inventive concept provides an adjustable child seat.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an adjustable child seat, including a main seat body to receive a user thereupon, a pivoting dome disposed on at least a portion of a bottom surface of the main seat body, a seat base to removably connect to the pivoting dome, such that the main seat body pivots with respect to the seat base via the pivoting dome, and rotates in response to a rotation of the seat base, and an alarm unit disposed on at least a portion of the seat base, the alarm unit including a tether disposed on at least a portion of the alarm unit to connect to a parent, such that the alarm unit generates an alert in response to the parent exceeding a range of the tether.

The pivoting dome may include a protruding member disposed within at least a portion of the pivoting dome.

The seat base may include a pivot lock to receive the protruding member therein, such that the pivoting dome is prevented from pivoting.

The seat base may include a seat base body, and a dome-receiving recess concavely disposed on at least a portion of the seat base body to receive the pivoting dome therein, such that the pivoting dome pivots with respect to the dome-receiving recess.

The seat base body may include a top portion, and a bottom portion disposed on at least a portion of a bottom surface of the top portion, such that the top portion rotates clockwise in a first direction, and counterclockwise in a second direction with respect to the bottom portion.

The seat base body may further include a swivel lock disposed on at least a portion of the seat base body to prevent the top portion from rotating in a first position, and to allow the top portion to rotate in a second position.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of an adjustable child seat, according to an exemplary embodiment of the present general inventive concept;

FIG. 2 illustrates a zoomed in front perspective view of a bottom of the adjustable child seat, according to an exemplary embodiment of the present general inventive concept; and

FIG. 3 illustrates an isometric top view of a seat base, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Adjustable Child Seat 100
Main Seat Body 110
Seat Cushion 111
Seatback 112
Headrest 113
First Head Pad 113a
Second Head Pad 113b
Cushion Guards 120
Seatbelt 130
Shoulder Portion 131
Pelvic Portion 132
Pivoting Dome 140
Protruding Member 141
Seat Base 150
Seat Base Body 151
Top Portion 151a
Bottom Portion 151b
Dome-Receiving Recess 152
Pivot Lock 153
Protrusion-Receiving Groove 153a
Swivel Lock 154
Alarm Unit 160

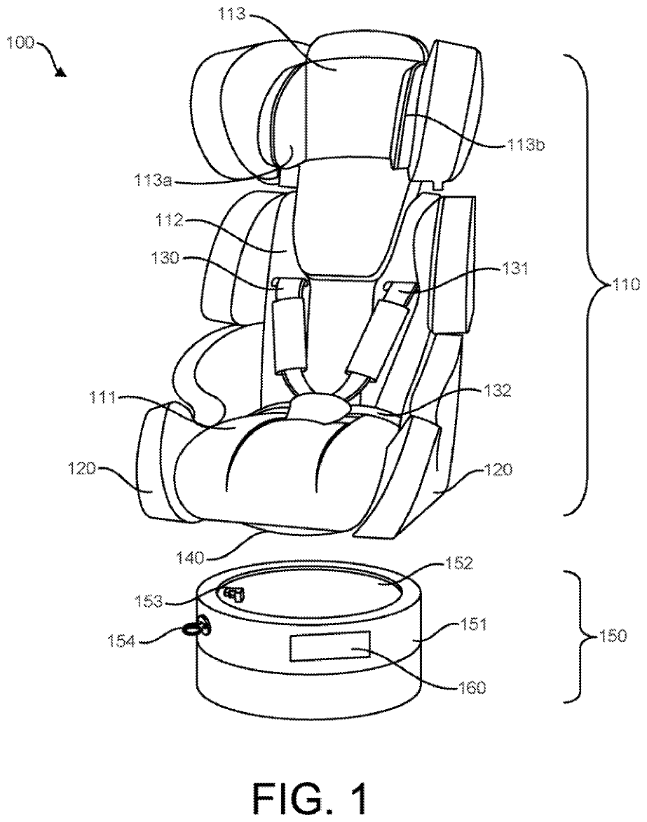

FIG. 1 illustrates a front perspective view of an adjustable child seat 100, according to an exemplary embodiment of the present general inventive concept.

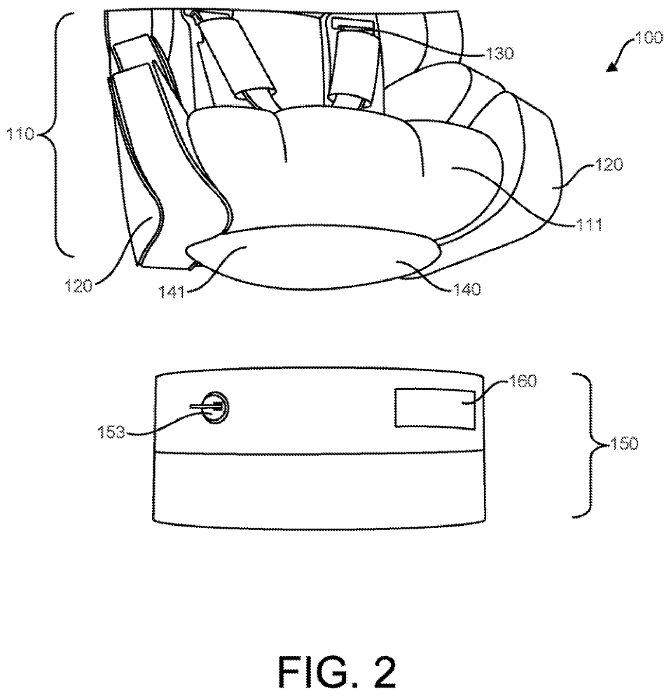

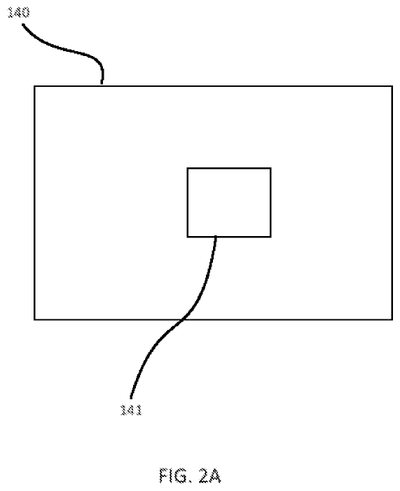

FIG. 2 illustrates a zoomed in front perspective view of a bottom of the adjustable child seat 100, according to an exemplary embodiment of the present general inventive concept.

The adjustable child seat 100 may be constructed from at least one of metal, plastic, wood, and rubber, etc., but is not limited thereto.

The adjustable child seat 100 may include a main seat body 110, a plurality of cushion guards 120, a seatbelt 130, a pivoting dome 140, a seat base 150, and an alarm unit 160, but is not limited thereto.

The main seat body 110 may include a seat cushion 111, a seatback 112, and a headrest 113, but is not limited thereto.

The seat cushion 111 may be constructed of a soft cushion to receive a user, such as a child, an adult, an animal, and/or an object thereupon. More specifically, the seat cushion 111 may at least partially deform in response to the user being disposed thereupon.

The seatback 112 may be constructed of a soft cushion to receive the user thereupon. More specifically, the seatback 112 may at least partially deform in response to the user being disposed thereupon.

The headrest 113 may include a first head pad 113a and a second head pad 113b, but is not limited thereto.

The headrest 113 may be constructed of a soft cushion to receive the user thereupon. More specifically, the headrest 113 may at least partially deform in response to the user being disposed thereupon.

The first head pad 113a may be disposed on at least a portion of a first side of the headrest 113. The second head pad 113b may be disposed on at least a portion of a second side of the headrest 113. Additionally, the first head pad 113a and the second head pad 113b may perpendicularly extend away from the headrest 113 in a direction. Moreover, the first head pad 113a and the second head pad 113b may prevent a head of the user from injury. More specifically, the first head pad 113a and the second head pad 113b may prevent the head of the user from sudden movement and/or moving in a first lateral direction or a second lateral direction that causes discomfort to the user, such as a jerking motion that would otherwise cause the head to strike a shoulder of the user.

The plurality of cushion guards 120 may be constructed of a hard cushion and/or a soft cushion based on a preference of a parent. The plurality of cushion guards 120 may be disposed on at least a portion of the main seat body 110. More specifically, the plurality of cushion guards 120 may be disposed on at least a portion around each side of the main seat body 110 to prevent the user from injury in response to striking an external object. For example, the plurality of cushion guards 120 may protect the user from injury during an accident in a vehicle.

The seatbelt 130 may include a shoulder portion 131 and a pelvic portion 132, but is not limited thereto.

The seatbelt 130 may be disposed on and/or within at least a portion of the main seat body 110. The seatbelt 130 may prevent the user from injury in response to striking the external object. For example, the seatbelt 130 may protect the user from injury during an accident in the vehicle.

The shoulder portion 131 may be disposed around shoulders of the user. The pelvic portion 132 may be disposed around at least a portion of a pelvis of the user. In other words, the shoulder portion 131 and the pelvic portion 132 may be interconnected around a body of the user to protect the user therein.

The pivoting dome 140 may including a protruding member 141, but is not limited thereto.

The pivoting dome 140 may be constructed of a smooth surface. The pivoting dome 140 may be disposed on at least a portion of a bottom surface of the main seat body 110.

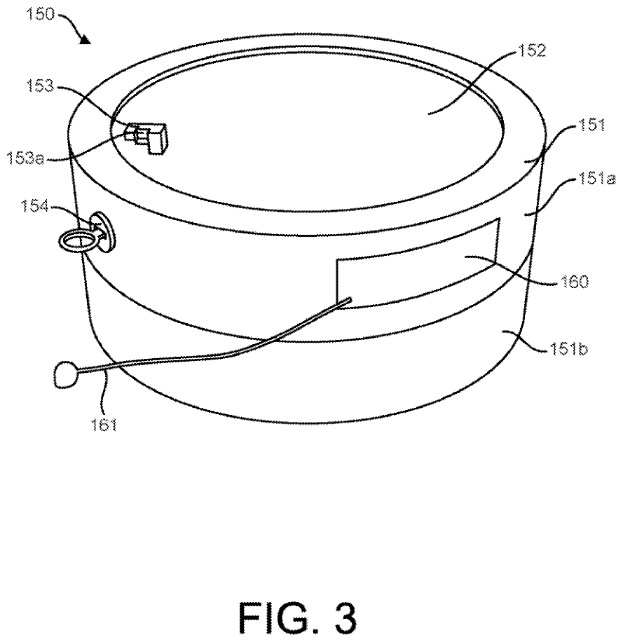

FIG. 3 illustrates an isometric top view of a seat base 150, according to an exemplary embodiment of the present general inventive concept.

The seat base 150 may include a seat base body 151, a dome-receiving recess 152, a pivot lock 153, and a swivel lock 154, but is not limited thereto.

Referring to FIGS. 1 through 3, the seat base body 151 is illustrated to have a cylindrical shape. However, the seat base body 151 may be a rectangular prism, conical, rectangular, circular, pentagonal, hexagonal, octagonal, or any other shape known to one of ordinary skill in the art, but is not limited thereto.

The seat base body 151 may include a top portion 151a and a bottom portion 151b, but is not limited thereto.

The top portion 151a may be disposed on at least a portion of a top surface of the bottom portion 151b. In other words, the bottom portion 151b may be disposed on at least a portion of a bottom surface of the top portion 151a. Furthermore, the top portion 151a may rotate in a first direction (i.e. clockwise) or a second direction (i.e. counterclockwise) to move the main seat body 110. In other words, the main seat body 110 may move in response to a rotation of the top portion 151a with respect to the bottom portion 151b. As such, the user may be oriented in multiple directions, other than facing a single direction, which is common among standard child seats.

The dome-receiving recess 152 may be concavely disposed on at least a portion of the seat base body 151, such that the dome-receiving recess 152 may extend into at least a portion of the top portion 151a and at least a portion of the bottom portion 151b. In other words, the dome-receiving recess 152 may be recessed with respect to a top edge of the top portion 151a.

The dome-receiving recess 152 may have a predetermined size corresponding to a size of the pivoting dome 140. Furthermore, the dome-receiving recess 152 may receive the pivoting dome 140 therein, such that the pivoting dome 140 may be removably connected to the dome-receiving recess 152. The pivoting dome 140 may pivot in any feasible direction within the dome-receiving recess 152. For example, the pivoting dome 140 may pivot, such that the main seat body 110 moves forward, backward, and/or towards a left side or a right side with respect to a current position of the user within the main seat body 110.

The protruding member 141 may be disposed on and/or within at least a portion of the pivoting dome 140. The protruding member 141 may be depressed a first time to extend out from within the pivoting dome 140. In other words, the protruding member 141 may include a spring, such that the protruding member 141 extends in response to being depressed, such that the spring extracts the protruding member 141.

Alternatively, the protruding member 141 may be depressed a second time to retract within the pivoting dome 140, such that the protruding member 141 remains inside the pivoting dome 140. For example, the protruding member 141 may click within the pivoting dome 140 in response to being depressed the second time by connecting to a lever within the pivoting dome 140.

The pivot lock 153 may include a protrusion-receiving groove 153a, but is not limited thereto.

The pivot lock 153 may be disposed on and/or within at least a portion of the dome-receiving recess 152. The pivot lock 153 may be depressed a first time to extend out from within the dome-receiving recess 152. In other words, the pivot lock 153 may include another spring, such that the pivot lock 153 extends in response to being depressed, such that the another spring extracts the pivot lock 153.

Alternatively, the pivot lock 153 may be depressed a second time to retract within the dome-receiving recess 152, such that the pivot lock 153 remains inside the dome-receiving recess 152. For example, the pivot lock 153 may click within the dome-receiving recess 152 in response to being depressed the second time by connecting to another lever within the dome-receiving recess 152.

Furthermore, the protrusion-receiving groove 153a may receive the protruding member 141 therein. In other words, the protruding member 141 may be inserted within the protrusion-receiving groove 153a to prevent the pivoting dome 140 from moving (i.e. pivoting). As such, the pivoting dome 140 may be locked. Alternatively, the pivoting dome 140 may be unlocked by moving the pivoting dome 140, such that the protruding member 141 moves away from the protrusion-receiving groove 153a.

The swivel lock 154 may be disposed on at least a portion of the seat base body 151. The swivel lock 154 may be rotated in first direction (i.e. clockwise) or a second direction (i.e. counterclockwise) from a first position (i.e. unlocked) to a second position (i.e. locked), such that the top portion 151a may be prevented from rotating with respect to the bottom portion 151b. Alternatively, the swivel lock 154 may be rotated in the second direction or the first direction from the second position to the first position, such that the top portion 151a may be allowed to rotate with respect to the bottom portion 151b.

The alarm unit 160 may include a tether 161, but is not limited thereto.

The alarm unit 160 may also include a speaker, a display unit, and a power source (e.g., a battery, a solar cell, etc.).

Referring again to FIGS. 1 through 3, the alarm unit 160 is illustrated to be disposed on the seat base 150. However, the alarm unit 160 may be disposed on at least a portion of the main seat body 110 and/or on the seat base 150.

The tether 161 may be a wired connection, such as a wire and/or a cord connected to a clothing of the parent. Alternatively, the tether 161 may be a wireless connection to connect to a mobile device of the parent. The wired and/or wireless connection may communicate via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The tether 161 may break in response to the parent moving beyond a range of the tether 161. Moreover, the alarm unit 160 may emit a sound via the speaker and/or display a warning and/or flash a light on the display unit in response to the tether 161 being broken. As such, the alarm unit 160 may an alert in response to the parent exceeding a range of the tether 161. As such, the parent is notified that the user is still within the main seat body 110. As such, the tether 161 may be connected to the parent when the user is in the main seat body 110, such that the alarm unit 160 may not be activated if the tether 161 is not used.

Therefore, the adjustable child seat 100 may facilitate insertion within the vehicle because of the ability to pivot and rotate, such that the parent does not strain a back muscle while inserting the adjustable child seat 100 within the vehicle. Also, the adjustable child seat 100 may prevent the parent from forgetting the user is in the vehicle due to the alarm unit 160.

The present general inventive concept may include an adjustable child seat 100, including a main seat body 110 to receive a user thereupon, a pivoting dome 140 disposed on at least a portion of a bottom surface of the main seat body 110, a seat base 150 to removably connect to the pivoting dome 140, such that the main seat body 110 pivots with respect to the seat base 150 via the pivoting dome 140, and rotates in response to a rotation of the seat base 150, and an alarm unit 160 disposed on at least a portion of the seat base 150, the alarm unit 160 including a tether 161 disposed on at least a portion of the alarm unit 160 to connect to a parent, such that the alarm unit 160 generates an alert in response to the parent exceeding a range of the tether 161.

The pivoting dome 140 may include a protruding member 141 disposed within at least a portion of the pivoting dome 140.

The seat base 150 may include a pivot lock 153 to receive the protruding member 141 therein, such that the pivoting dome 140 is prevented from pivoting.

The seat base 150 may include a seat base body 151, and a dome-receiving recess 152 concavely disposed on at least a portion of the seat base body 151 to receive the pivoting dome 140 therein, such that the pivoting dome 140 pivots with respect to the dome-receiving recess 152.

The seat base body 151 may include a top portion 151a, and a bottom portion 151b disposed on at least a portion of a bottom surface of the top portion 151a, such that the top portion 151a rotates clockwise in a first direction, and counterclockwise in a second direction with respect to the bottom portion 151b.

The seat base body 151 may further include a swivel lock 154 disposed on at least a portion of the seat base body 151 to prevent the top portion 151a from rotating in a first position, and to allow the top portion 151a to rotate in a second position.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An adjustable child seat, comprising:
a main seat body to receive a user thereupon;
a pivoting dome disposed on at least a portion of a bottom surface of the main seat body, the pivoting dome comprising:
a protruding member disposed within at least a portion of the pivoting dome to extend out from within the pivoting dome in response to being depressed a first time and retract within the pivoting dome in response to being depressed a second time;
a seat base to removably connect to the pivoting dome, such that the main seat body pivots in any direction in at least one of forward, backward, left, and right with respect to the seat base via the pivoting dome, and rotates in response to a rotation of the seat base; and
an alarm unit disposed on at least a portion of the seat base, the alarm unit comprising:
a tether comprising a cord disposed on at least a portion of the alarm unit to physically connect to a parent, such that the alarm unit generates an alert in response to the cord being broken while connected to the parent.

2. (canceled)

3. The adjustable child seat of claim 1, wherein the seat base comprises:
a pivot lock to receive the protruding member therein, such that the pivoting dome is prevented from pivoting.

4. The adjustable child seat of claim 1, wherein the seat base comprises:
a seat base body; and
a dome-receiving recess concavely disposed on at least a portion of the seat base body to receive the pivoting dome therein, such that the pivoting dome pivots with respect to the dome-receiving recess.

5. The adjustable child seat of claim 4, wherein the seat base body comprises:
a top portion; and
a bottom portion disposed on at least a portion of a bottom surface of the top portion, such that the top portion rotates clockwise in a first direction, and counterclockwise in a second direction with respect to the bottom portion.

6. The adjustable child seat of claim 5, wherein the seat base body further comprises:
a swivel lock disposed on at least a portion of the seat base body to prevent the top portion from rotating while the swivel lock is in a first position, and to allow the top portion to rotate while the swivel lock is in a second position.

7. An adjustable child seat, comprising:
a main seat body to receive a user thereupon;
a pivoting dome constructed of a smooth surface and disposed on at least a portion of a bottom surface of the main seat body, the pivoting dome comprising:
a protruding member disposed within at least a portion of the pivoting dome to extend out from within the pivoting dome in response to being depressed a first time and retract within the pivoting dome in response to being depressed a second time;
a cylindrical shaped seat base, comprising:
a bottom portion,
a top portion disposed on at least a portion of a top surface of the bottom portion to rotate clockwise in a first direction and counterclockwise in a second direction, such that a diameter of the bottom portion is equivalent to a diameter of the top portion, and
a dome-receiving recess concavely disposed on at least a portion of the top portion and extending into the bottom portion to receive the pivoting dome therein, such that the main seat body pivots in any direction in at least one of forward, backward, left, and right with respect to the cylindrical shaped seat base via the pivoting dome and rotates in response to a rotation of the top portion; and
an alarm unit disposed on at least a portion of the cylindrical shaped seat base, the alarm unit comprising:
a tether disposed on at least a portion of the alarm unit to connect to a parent, such that the alarm unit generates an alert in response to the parent exceeding a range of the tether.
